(19) United States
(12) Patent Application Publication
(10) Pub. No.: US 2017/0320291 A1
(43) Pub. Date: Nov. 9, 2017

(54) Health protecting and Fuel Saving Modular Multi-Purpose Insulating Device for Domestic & Commercial Heat Emitters thereby increasing main storage capacity to extend fuel coverage and creating carbon credits in the process

(71) Applicants: John Douglas Tolmer, Calle Calders (ES); James B. Goldsmith, New Orleans, LA (US)

(72) Inventors: John Douglas Tolmer, Calle Calders (ES); James B. Goldsmith, New Orleans, LA (US)

(21) Appl. No.: 15/149,140

(22) Filed: May 8, 2016

(51) Int. Cl. B32B 7/12; E04B 1/78; B32B 3/28; B32B 15/08; B32B 15/20

(52) U.S. Cl. CPC B32B 7/12; B32B 15/08; B32B 15/20; B32B 3/28; E04B 1/78; B32B 2250/03; B32B 2255/10; B32B 2307/7244; B32B 2307/7265; B32B 2607/02; B32B 2307/304

(57) ABSTRACT

The invention relates to creating health benefits from an energy efficient thermal insulation device of a reinforced impermeable aluminum sheet combined with a protective cover divided into a number of air filled square and rectangular shaped modules that provide health and comfort benefits by improving indoor and outdoor air quality and indoor air circulation by reducing energy flux through the building fabric where the insulating device is fixed to a wall or free standing behind a heat emitter and thereby reducing the heating fuel consumption and therefore storage requirements of heating fuel and thereby extending fuel reach for the fuel supplier and reducing carbon dioxide emissions into the atmosphere.

### FIELD OF THE INVENTION

The present invention relates to efficient use of heat emitter energy and has been developed to insulate heat emitters/heat generators from causing heat exchange through walls which impacts on wall insulation and wall coatings that can release volatile hazardous chemicals into the indoor and outdoor air. The resulting impact on indoor air quality can have serious consequences to the well-being of the occupants. Thus, by improving air quality and air circulation in the space to be heated by insulating the wall fabric behind and above a heat emitter from having to maintain a designed heat loss through the wall during space heating due to heat exchange and will be described primarily with reference to this application.

### BACKGROUND OF THE INVENTION

The present invention aims at the deficiencies of the existing/known technology of single or double sheet reflectors of profiled polymer film coated with a thin layer of vacuum deposited aluminum. However, they suffer from various disadvantages such as the permeability of the coated film to oxygen, water and microorganisms due to the many pinhole defects and fractures in both the polymer layer and the adjacent metal coating.

### OBJECTS OF THE INVENTION

The object of the invention is to create a device that is impermeable to oxygen, water and microorganisms. The primary benefit of installing this modular insulating device is to insulate heat emitters of any dimension from heat exchange that will cause the breakdown of insulation materials and wall coatings into fine air born particulates that building occupants breathe in during their stay in a space heated employing heat emitters attached to walls or free standing. Moreover, to improve air quality and air circulation in the space to be heated, the insulating device limits the energy flux through the wall fabric of a building either fixed to a wall behind a heat emitter or free standing between a wall and a heat emitter.

The insulating device reduces the heat loss effects from thermal exchange of convection, conduction and radiation. In thermodynamics, convection refers specifically to heat transfer by movement of warm particles, and conduction involves direct contact of atoms and radiation involves the movement of electromagnetic waves. The insulating device thermodynamically improves air quality and air circulation by improving the heat output of the heat emitter in the space to be heated. The insulating device is retrofitted to existing heat emitters or included as an integral part of new heat emitter manufacture, significantly reducing heat transfer by insulating the wall directly behind and above a heat emitter from the heat emitter itself.

Regardless of the fuel source be it solar, geothermal, natural gas, electric, solid fuel or another fuel source, the modular insulating device achieves a fuel saving by reducing the effect of a designed heat loss in the wall fabric of a building. The effect of eliminating the heat loss through the wall behind the heat emitter increases the comfort level of the space to be heated by improving the quality and circulation of air by causing a stronger fluid flow of hot air into the space to be heated. The installation of an insulating device to a wall behind a heat emitter ensures that the water in the heating system now returns to the boiler at a higher temperature allowing for a lower thermostat setting to achieve the same level of comfort using less energy and thereby reducing the financial cost of space heating.

The insulating device may be cut to heat emitter size without waste by professional, and non-professional installers alike to facilitate insulating device installation behind heat emitters either free standing or fixed to walls without removing the heat emitter.

The installation of an insulating device with a flat aluminum sheet minimum thickness to be impermeable to oxygen and water with the reflective side permanently bonded to a white profiled polymer front protective cover with a supporting polymer sheet bonded or laminated to the matte side of the aluminum sheet. The device eliminates the need for a heat emitter to maintain a designed heat loss in the wall fabric of a building caused by moisture migration in the molecular make up of brick, cement, wood, insulation fibers and other organic materials. Molecules contain moisture, and when heat is introduced to a molecule, moisture expansion occurs leading to moisture migration carrying the heat through the building fabric of a wall and out of the building. A heat emitter free standing or fixed to a wall may lose up to 40% of its heat to a wall and the heat emitter will first need to maintain this designed loss in the wall fabric of the building, before it is able to heat the air in a room space.

Heat emitters waste up to 40% of their heat, principally lost through walls directly behind a heat emitter. To compensate for this loss, extra fuel is burnt needlessly, pumping out unnecessary carbon dioxide into the atmosphere every year contributing to global warming and air pollution. The insulating device reduces fuel use enabling the thermostat to be turned down to achieve the same level of comfort without the occupants of the building noticing a drop in temperature setting.

Without an insulating device, a building, central heated by heat emitters, free standing or fixed to the walls wastes fuel at the boiler, principally due to the “primary loss” of heat through the wall fabric directly behind and above the wall or window where a heat emitter is either free standing or fixed to a wall. Installing an insulating device increases the thermal resistance of the wall and reduces the radiant heat transfer to the wall while increasing the airflow over both sides of the heat emission surface of the heat emitter, improving its heat output.

By improving the air circulation in a clockwise direction, eddy currents may carry warm air to the far wall, returning to the corner under the heat emitter. The improved airflow will give the air a powerful upward flow into the gap between the heat emitter and the stagnant air limit layer formed in front of the systems insulating device. The upward hot air flow on both sides of the heat emitter meets and heats the cold airflow coming down the wall thermodynamically sweeping the heated air out into the room in a clockwise eddy flow positively modifying the flow pattern of air in the space to be heated.

The object of the insulating device of the present invention is to provide an improved insulation device made up of a sheet of heat deflective white polymer laminated to aluminum sheet forming at least two separate sections that are air filled when sealed together. The front section of the insulating device is made of a white heat deflective polymer including a plurality of right angle transverse shaped sections that may be placed as a protective cover over the shiny/reflective side of a flat sheet of aluminum eliminating foreign bodies including grease, dirt and dust depositing on the reflective front surface of the aluminum that would otherwise depreciate the emissivity or reflective properties of the radiant surface of the aluminum. The protected clean flat aluminum surface re-emits or reflects approximately 98% of medium and far infrared radiation on a continuous basis due to the protective front cover.

The insulating device including the components of white heat deflective polymer and aluminum do not endanger the health of workers, consumers or the environment and all components of the modular systems insulating device are recyclable.

The insulating device is designed to fit any size heat emitter by adding to or removing from an insulating device module sections. Thereby, eliminating the problem of left over waste of material during installation of the insulating device, making it a cost effective, simple and time efficient process to install an insulating device. Just cut to size along the cut lines aided by the use of a slide guide, then remove the back adhesive cover and press the insulating device section to the wall without removing the heat emitter from the wall.

### SUMMARY OF THE INVENTION

The air filled insulating device eliminates the heat exchange of a “primary” heat loss through the wall behind and above a heat emitter thereby improving the air quality by increasing the thermal resistance of the wall and reducing the radiant heat transfer to the wall behind and a window or wall above a heat emitter. The insulating device reduces fuel consumption at the boiler by heating the same volume of air in a building space with less energy, in a faster warm up time. Also the insulating device improves both the quality of air and air circulation and has the effect of contemporaneously slowing down the “secondary” heat loss through the walls, floor, ceiling and windows in the space to be heated.

An air filled insulating device may be retrofitted to all types and dimensions of wall mounted or free standing heat emitters and may be an integral part of new heat emitter manufacture, or used as a cavity wall, ceiling or forced air duct insulation new or as a retrofit insulation product for ducting. The insulating device has been designed to eliminate waste of material during installation resulting in no unusable sections of the systems insulating device that are left over after an installation has been completed.

### BRIEF DESCRIPTION OF THE DRAWINGS

The insulating device of the present invention may be understood by reference to the following description taken in conjunction with the accompanying figures, in which, like reference numerals identify like elements, and in which:

FIG. 1 illustrates a side view of an air filled three piece sealed insulating device of the present invention;

FIG. 2a illustrates a side view of an air filled two-piece sealed unit insulating device of the present invention;

FIG. 2b illustrates a portion of a right angle section and a flat aluminum sheet;

FIG. 3 illustrates a front view of an insulating device with horizontal and vertical bonding channels;

FIG. 4 illustrates a front view of four different modular sections of insulating device of different sizes with vertical and horizontal cut and bonding channels;

FIG. 5 illustrates a heat emitter support bracket with a plurality of transverse right angle sections;

FIG. 6 illustrates air circulation on both sides of the heat emitter;

FIG. 7 illustrates air circulation on both sides of the heat emitter “without” the insulating device behind a heat emitter;

FIG. 8 illustrates airflow with insulating device positioned behind two heat emitters;

FIG. 9 illustrates a cavity wall filled with insulation material and internal wall coatings with the insulating device;

FIG. 10 illustrates the breakdown of cavity wall insulation and the deterioration of wall coatings without the insulating device;

FIG. 11 illustrates forced air ducting of various shapes that may be retrofitted with an insulating device and new ducting being manufactured including the insulating device.

### DETAILED DESCRIPTION OF THE INVENTION

A modular insulating device reduces the consumption of heating fuel and therefore extending the storage requirements for heating fuel by the percentage of fuel savings, and additionally reducing carbon emissions in the process. The insulating device may include a non-toxic flat aluminum sheet laminated with a flat white or other color heat deflective polymer on the matte side of the aluminum sheet. The aluminum sheet may be thick enough to be impermeable to oxygen, water and micro-organisms and may include a front cover formed of white modular square and rectangular profiled sections of heat deflective polymer attached to the shiny/reflective side of the flat aluminum sheet. The thickness of the aluminum sheet may eliminate the probability of pinholes and foil fractures in the aluminum sheet from occurring during fabrication, handling and installation of the device. The thick aluminum sheet may stop the transmission of oxygen, water and microorganisms as opposed to the poor performance of thin 50 microns aluminum foil that develops pinholes and foil fractures during fabrication, and where handling and installation exacerbate the problem. The shiny/reflective side of the aluminum sheet may be permanently bonded to a white or other color profiled heat deflective modular square or rectangular shape formed in polymer or other material front protective cover which may have a plurality of transverse right angle sections that define the air filled modules. The insulating device may be placed between a wall and a heat emitter and the matte side of the flat aluminum sheet may be laminated or bonded to a layer of polymer that may prevent the aluminum sheet from sagging between the air filled modules and the front protective cover and thereby preventing heat loss from conduction. The flat sheet of polymer may have a layer of adhesive and a protective liner and when the liner is removed the device may be able to be bonded to the wall. The insulating device creates health benefits by reducing heat exchange from a heat emitter to a wall from the deleterious effects of convection, conduction and radiation on a building envelope directly behind and above a heat emitter that is free standing or fixed to a wall. The insulating device eliminates heat exchange from the heat emitter to the wall removing the potential hazards of heart and lung disease which are exacerbated by the release of air pollutants of volatile organic compounds and fine particulate matter from the wall area directly behind the heat emitter, pollutants and volatile organic compounds that would otherwise increase the risk to building occupants of being hospitalised or dying from heart failure, and the risk of lung cancer which increases after prolonged exposure to volatile organic compounds and fine particulate matter. Once inhaled volatile organic compounds and fine particulate matter are small enough to pass from the lungs to the blood stream unleashing a range of health problems.

The insulating device of the present invention reduces carbon dioxide emissions into the indoor air space and the atmosphere by the sum of the fuel savings. Fuel is burned inside or outside of a building envelope to create energy to keep warm in buildings, place of business and other indoor pursuits. A standard amount of carbon dioxide may be released outdoors and indoors when heating fuel is first created in a power plant then burnt up within a building envelope creating many tonnes of direct carbon dioxide emissions per fuel per person per year. By adding an insulating device to insulate a heat emitter from losing heat to the wall area directly behind the heat emitter may allow a person to remain warm and free from the release of fine particulate matter into the room, with thermostat setting lowered by 2 or more degrees saving fuel and carbon emissions each year.

The insulating device of the present invention improves the indoor air quality, creating health benefits by limiting the effects of concentrated heat exchange through the wall area directly behind a heat emitter by employing an aluminium reflective sheet that is impermeable to oxygen and water and is laminated on the matte side with a white flat heat deflective polymer sheet. Without the insulating device in place, the effects of heat exchange would otherwise break down wall insulation materials and wall coatings thereby releasing volatile hazardous chemicals into the air in a heated space, which can have serious consequences to the wellbeing of the occupants in a building. Elements of common wall insulation such as fibreglass are listed as possible carcinogens. Over time these elements breakdown with heat exchange and small particles will become airborne within a building. Nitrogen dioxide (NO₂), sulphur dioxide (SO₂), polycyclic aromatic hydrocarbons (PAHs), volatile organic compounds (VOCs), benzene, ozone (O₃) and particulates are harmful to the lungs and may trigger serious illnesses. Persons suffering from respiratory problems are particularly sensitive to any deterioration in air quality; CFCs and HCFCs still remain in the insulation of many buildings and continue to have an impact on the ozone layer.

The insulating device of the present invention may include a semi-rigid and flexible device with a plurality of transverse right angle sections on the front surface that are divided into square and rectangular shaped modules and bonded to a flat aluminum sheet that may have a flat polymer sheet bonded to the matte side of the aluminum sheet to stop the aluminum sheet from sagging, creating enclosed air filled spaces that reduce the heat losses from conduction without which a heat emitter would otherwise need to maintain a designed heat loss from conduction through the wall fabric of the building directly behind a heat emitter before it is able to heat the air in a room.

The modular insulating device of the present invention may include the plurality of transverse right angle sections of white heat deflective polymer on the front cover of the insulating device where the airflow may induce eddies or vortices to form in the hollow of each shape keeping the white front surface cool to the touch and clean from grease, dust and dirt deposits. The eddies or vortices force the convective airflow away from the insulating device front cover surface back towards the heat source and out into the space to be heated. An increase in airflow velocity in the space between the insulating device and a heat emitter may have a positive effect on the airflow over both sides of the emission surfaces of a heat emitter, improving both the heat output of the heat emitter and the velocity of the airflow into the space to be heated causing a faster warm up time to occur in the space to be heated using less heating fuel in the process.

The insulating device of the present invention may include the white profiled heat deflective front polymer cover which may protect the flat radiant aluminum sheet surface from grease, dust and dirt being deposited on its reflective surface thereby retaining its emissivity and allowing it to continuously, without obstruction reflect or re-emit up to 98% of the medium and far infrared radiation back towards the heat source and out into the space to be heated.

The insulating device of the present invention may be placed between a heat emitter and a wall, and the heat emitter may be either free standing or fixed to the wall, and where the temperature range is greatest, the present invention may produce fuel savings by reducing the pre-heating time of a building and in doing so eliminates the effect of transient heat loss from night-time setback of heat emitter temperature where heat losses occur from the dynamic effects of heating and cooling a building, especially in evaporating water from outside walls during the day, to be replaced by cold water condensing during the night.

The insulating device of the present invention may save fuel in the space to be heated by returning water to the boiler at a higher temperature therefore the thermostat setting may be lowered to achieve the same level of comfort. Without the device installed behind a heat emitter, a poorly insulated wall can drop as much as 10 degrees in an hour.

The insulating device of the present invention may insulate a heat emitter of any dimension from heat loss wherein the airflow over the plurality of transverse right angle white heat deflective sections on the front protective and modular cover of the insulating device to create eddies or vortices in cavities creating a limit layer of air in front of the insulating device pushing the hot air stream away from the insulating device back towards the heat source and out into the space to be heated.

The insulating device of the present invention may reduce heat loss from a heat emitter to the wall fabric of a building. This heat loss increases the temperature differential gradient between the inside and outside of the wall fabric. The higher the temperature gradient differential the higher the heat loss will be through the wall behind and above the heat emitter. The insulating device stops this thermal transfer of heat through the wall, saving energy consumption at the boiler or furnace.

The insulating device of the present invention may include air filled modules have a channel around the perimeter of each separate air filled module to protect the structural integrity of the air filled insulation space when separating the modules with a knife or cutter to increase or decrease the device size to accommodate the many heat emitter sizes.

The insulating device of the present invention may insulate a heat emitter of any dimension from heat loss. The insulating device may be an integral part of a new heat emitter design or new ducting insulation or as a retrofit to insulate existing forced air ducting.

The insulating device of the present invention may insulate a heat emitter of any dimension from heat loss. The insulating device produces health benefits by preventing a breakdown of the cavity wall insulation materials and the deterioration and discoloration of the wall behind and above a heat emitter by pushing the convective airflow away from the wall and preventing a breakdown of wall coatings of paper, paint, or plaster and other materials behind a heat emitter by reducing thermal exchange in the wall area behind and above a heat emitter.

The insulating device of the present invention may achieve fuel savings regardless of the fuel source be it solar, geothermal, natural gas, electric, solid fuel or another fuel source the modular insulating device by reducing the effect of a designed heat loss in the wall fabric of a building. The effect of eliminating the heat loss through the wall behind the heat emitter increases the comfort level of the space to be heated by improving the quality and circulation of air by causing a stronger fluid flow of hot air into the space to be heated. The installation of an insulating device to a wall behind a heat emitter ensures that the water in the heating system now returns to the boiler at a higher temperature than without the insulating device allowing for a lower thermostat setting to achieve the same level of comfort using less energy and thereby reducing the financial cost of space heating.

The insulating device of the present invention with installation and with a flat aluminum sheet thick enough to be impermeable to oxygen and water with the shiny side permanently bonded to a white profiled polymer front protective cover with a supporting polymer sheet bonded or laminated to the matte side of the aluminum sheet. The device eliminates the need for a heat emitter to maintain a heat loss in the wall fabric of a building caused by moisture migration in the molecular make up of brick, cement, wood, insulation fibers and other organic materials. Molecules contain moisture and when heat is introduced to a molecule moisture expansion occurs leading to moisture migration carrying the heat through the building fabric of a wall and out of the building. A heat emitter free standing or fixed to a wall may lose up to 40% of its heat to a wall and the heat emitter will first need to maintain this designed loss in the wall fabric of the building, before it is able to heat the air in a room space.

The insulating device of the present invention being free standing or fixed to the walls reduces fuel waste at the boiler, principally due to the elimination of the “primary loss” of heat through the wall fabric directly behind and above the wall or window where a heat emitter is either free standing or fixed to a wall. Installing the insulating device increases the thermal resistance of the wall and reduces the radiant heat transfer to the wall while increasing the airflow over both sides of the heat emission surface of the heat emitter improving its heat out put into the space to be heated.

The insulating device of the present invention may improve the air circulation in a clockwise eddy to carry warm air to the far wall, returning to the corner under the heat emitter. The improved airflow may give the air a powerful upward flow into the gap between the heat emitter and the stagnant air limit layer formed in front of the insulating device. The improved upward hot air flow speed on both sides of the heat emitter meets and heats the cold airflow coming down the wall thermodynamically sweeping the now heated air out into the room in a clockwise eddy positively modifying the flow pattern of heated air in the space to be heated.

The insulating device of the present invention may be formed of components of white heat deflective polymer and aluminum that do not endanger the health of workers, consumers or the environment and all components of the modular systems insulating device are recyclable.

The insulating device of the present invention are may have a data collection chip on or in the insulating device to collect data information for utilities, fuel suppliers, health professionals and consumers.

The insulating device of the present invention may allow all indoor heating thermostats to operate by cooperating with the insulating device with a new maximum efficiency by recording and acting on energy efficiency on an unprecedented scale. As to date, thermostats may only record and collect data within the envelope of a building without the benefit of an insulating device to advise a thermostat to record and act upon the heat loss reduction performed on a permanent basis by the insulating device.

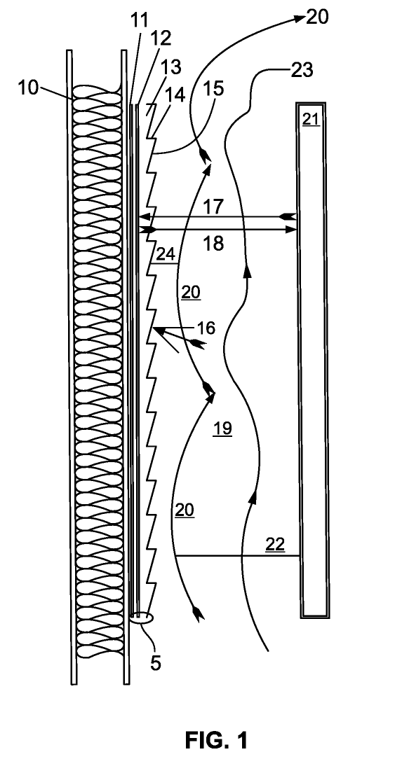

FIG. 1 illustrates a side view of an air filled three piece sealed insulating device 5 of the present invention that is fixed to an insulation filled cavity wall 10 with a layer of adhesive covering a sheet 11 of polymer; the insulating device 5 may be filled with air 13 or other types of fluid between an impermeable to oxygen and water, radiant, flat, aluminum sheet 12 (or other material) with a backing sheet 11 of polymer laminated to the matte/non-reflective side of the aluminum sheet 12 and a white polymer front cover 15 bonded to the reflective side of the aluminum 12 and positioned facing a heat emitter 21; the front white heat deflective polymer cover 15 includes modules each with a plurality of right angle transverse sections 16 that push the convective airflow 20 back towards the heat emitter 21 and out into the space to be heated. The incoming radiant heat 17 is re-emitted or reflected back to the heat source by the flat radiant aluminum sheet 12 that re-emits or reflects substantially 98% of medium and far infrared radiation 18 back to the heat source. The improved hot airflow 23 moving upwards along the front of the insulating device 5 is kept away from the wall 10 by the formation of a limit layer 24 of stagnant air formed by eddies 19 that form in the hollows 14 of the white right angle shaped heat deflective polymer cover 15 thereby reducing the distance between the front surface of insulating device 5 and the heat emitter 21 by the extent of the stagnant air limit layer 24. Narrowing the gap 22 between the insulating device 5 and the heat emitter 21 increases the velocity of the hot air stream over all the emission surfaces of the heat emitter 21 improving the heat output performance of the heat emitter 21 and positively modifying the air quality and the airflow pattern in the space to be heated;

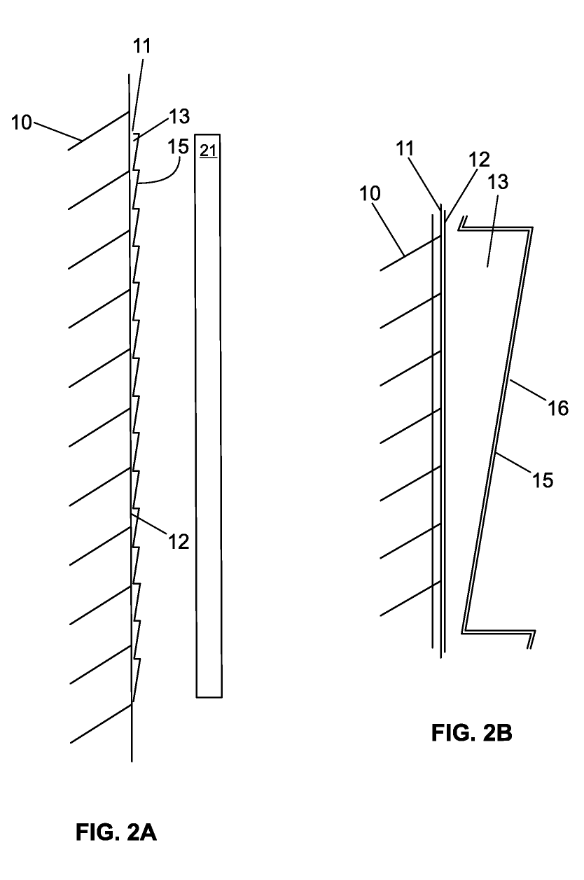

FIG. 2a illustrates a side view of an air filled two-piece sealed unit insulating device 5 of the present invention that is bonded to a wall 10 with a layer of adhesive covering over a white or other color heat deflective polymer 11 laminated to an aluminum sheet 12; the insulating device 5 may be filled with air 13 and is positioned between a wall 10 and a heat emitter 21; an enlarged view is shown in FIG. 2b of a right angle traverse section 16 of the cover 15 and a flat aluminum sheet 12 laminated with a backing sheet of white heat deflective polymer 11.

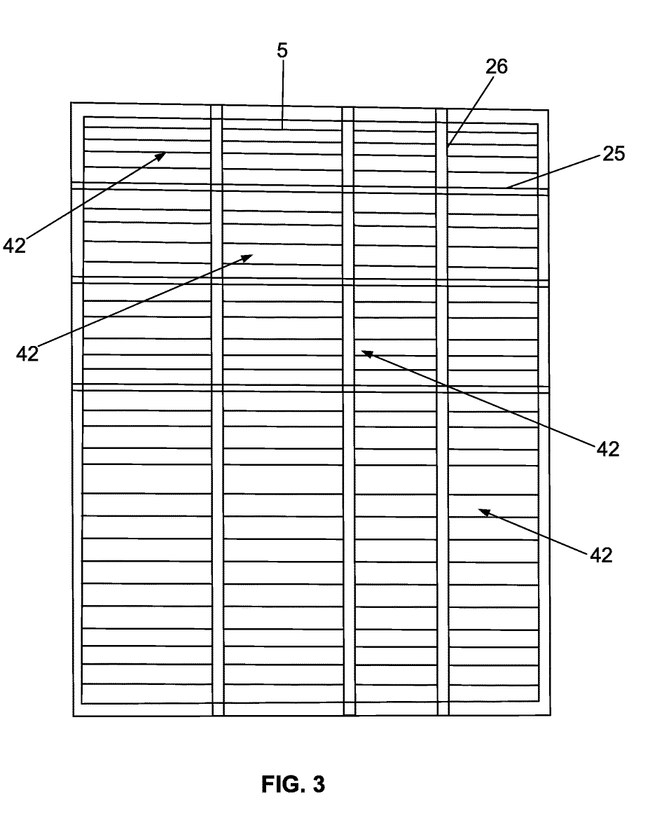

FIG. 3 illustrates a front view of universal heat emitters insulating device 5 with horizontal 25 and vertical 26 cut or bonding channels that separate the modules 42 on the insulating device 5 of the present invention to provide various sizes.

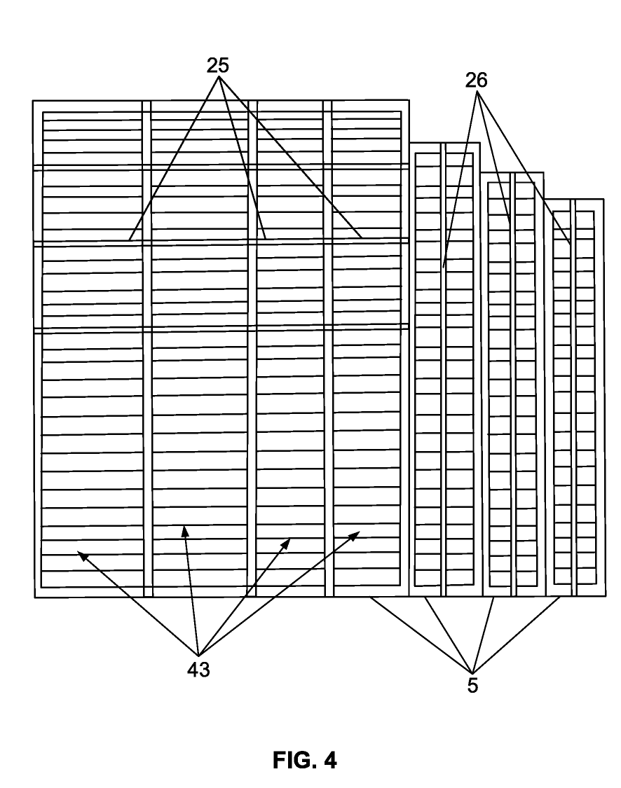

FIG. 4 illustrates a front view of four different modular sections of the insulating device 5 each being of different sizes with respect to the vertical and horizontal cut and bonding channels 25 and 26 that separate the modules 43 on the insulating device 5 to facilitate the ease of installation to accommodate the height and width of different heat emitters.

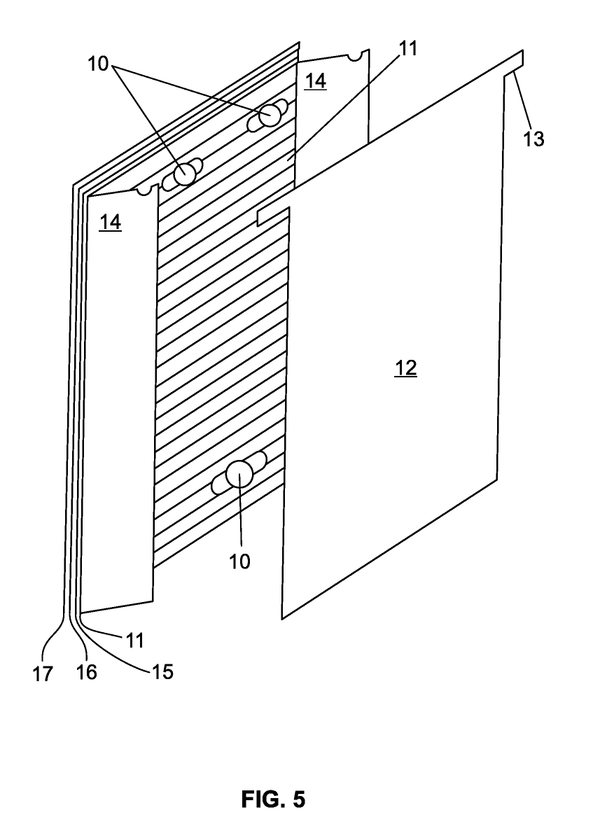

FIG. 5 illustrates a white or off-white or another color heat emitter 12 with a plurality of transverse right angle shapes 11 on the wall bracket part of the multi purpose insulating device 12 included as an integral part of a heat emitter or radiator manufacture in metal or another material. The multi purpose insulating device part 11 replaces brackets that would normally hold the heat emitter 12 to a wall. The insulating device is fixed to the wall with bolts or hooks inserted into slots 10 that allow space adjustment to position bolts or hooks or other fixing methods. The heat emitter 12 may be hung on or attached to side flaps 14 should the side flaps be incorporated as part of device as an alternative to other fixing methods. The insulating device 11 part of heat emitter 12 has a flat aluminum sheet 15 adhered to the flat rear side of 11 with a white polymer sheet or other material 16 covering the aluminum sheet 15 with an adhesive cover 17 that will be peeled off upon installation of heat emitter 12 to the wall. The adhesive cover 17 will allow the insulating device part 11 to be positioned on the wall to allow for ease of fixing before heat emitter 12 is attached or hung on the insulating device 11.

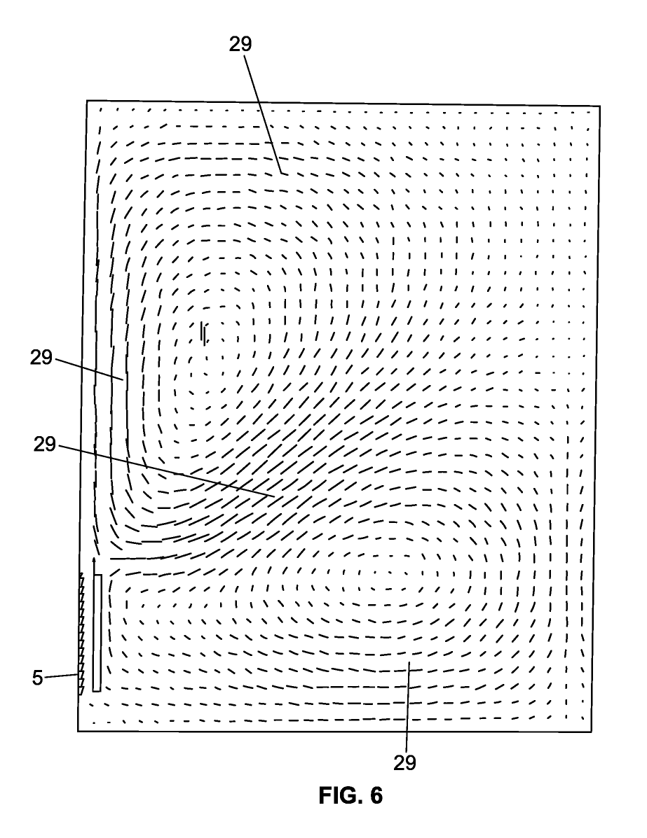

FIG. 6 illustrates strong air circulation 29 on both sides of the heat emitter 21 that positively modifies the airflow pattern with the insulating device 5 fixed to a wall behind a heat emitter 21.

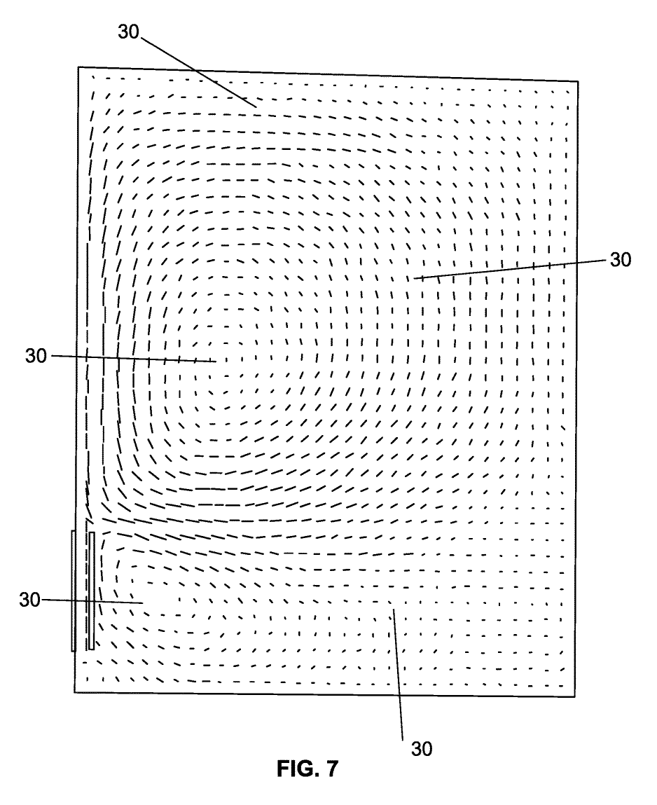

FIG. 7 illustrates weak air circulation 30 on both sides of the heat emitter “without” the insulating device behind a heat emitter.

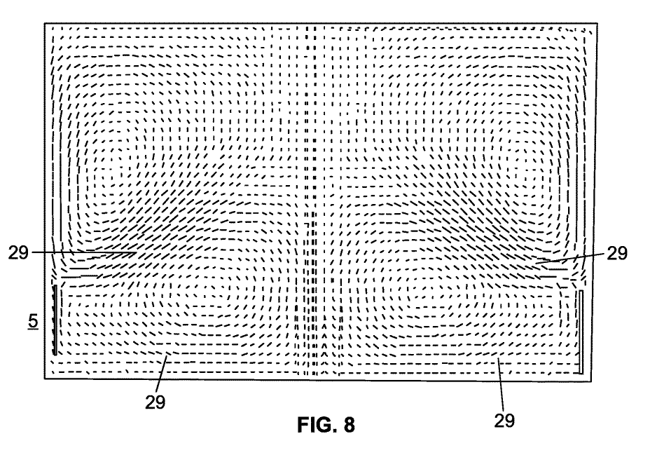

FIG. 8 illustrates airflow 29 with insulating device 5 installed behind two heat emitters 21 in a room space showing improved air circulation.

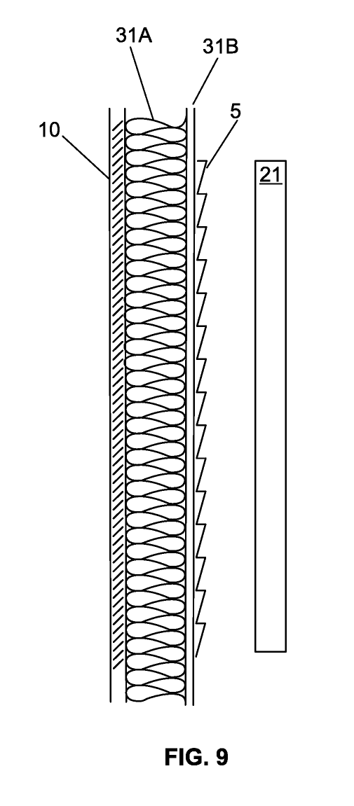

FIG. 9 illustrates the cavity wall 10 filled with the insulation material 31a and the internal wall coatings 31b being in contact with insulating device 5 being positioned between a heat emitter 21 and a wall 10.

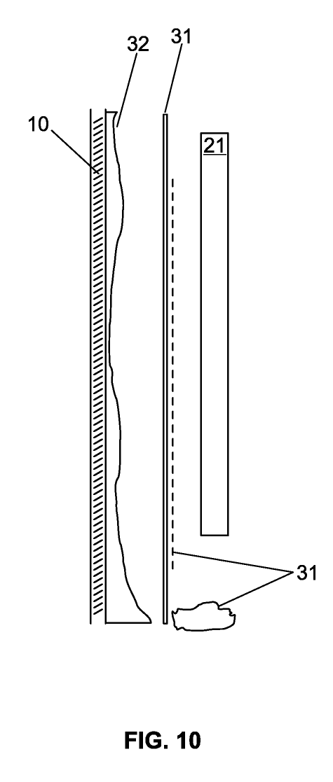

FIG. 10 illustrates the breakdown of the cavity wall insulation 32 and the deterioration of the wall coatings 31 without the insulating device 5 in place to stop heat exchange from breaking down the cavity wall insulation 32 and the deterioration of internal wall coatings 31.

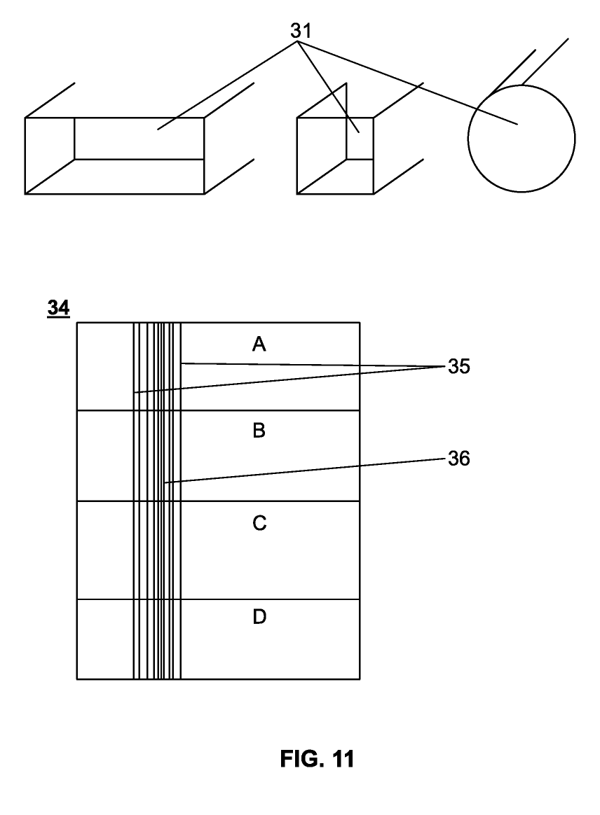

FIG. 11 illustrates the forced air ducting 33 of various shapes that may be retrofitted with an insulating device 5 and new ducting 34 being manufactured including the insulating device 5 with large deflecting facets 35 and small deflecting facets 36 on four duct sides a, b, c, d of the present invention.

FIG. 1 illustrates that the recyclable thermal insulating modular system insulating device 5 of the present invention eliminates fuel waste at the boiler by blocking the transfer of up to 40% of heat loss from a heat emitter 21, being lost through a wall 10, thereby eliminating the effects of a heat loss built into the wall fabric of a building. Furthermore, the inner flat radiant aluminum sheet 12 is protected from grease, dust and dirt by the plurality of transverse white heat deflective, right angle sections 16 of the front polymer cover 15 (or other materials) of the modular insulating device 5. The plurality of triangular sections 16 on the modular front cover 15 of the insulating device 5 may be cleaned due to the turbulence created by eddies or vortices 19 in the transverse hollows of the right angle section 16 on the front white or off white heat deflective polymer cover 15. The front white or off white or other polymer cover 15 of the insulating device 5 will not alter the emissivity or the performance of the inner radiant flat impermeable to water and oxygen aluminum sheet surface 12. Heat rays 17 do not recognize the right angle sections 16 on the front white or other color polymer cover 15 and are re-emitted or reflected heat rays 18 back towards the heat source when meeting the radiant inner flat aluminum surface 12 of the insulating device 5 eliminating the heat exchange through a wall thereby saving on fuel consumption and at the same time improving the quality of air and advantageously improving the airflow 23 into the space to be heated.

FIG. 1 illustrates the thermal insulating modular insulating device 5 with an air filled space 13 between a flat aluminum sheet 12 laminated with polymer backing sheet 11 and the front polymer cover 15 with a plurality of transverse white right angle sections 16 that when sealed form an air filled unit eliminating conduction by limiting thermal bridges in the insulating device 5.

FIG. 9 illustrates that the insulating device 5 may be a gas and moisture barrier by stopping heat exchange causing moisture expansion and moisture migration from the interior side of a wall and at the same time reducing the effect of night time set back of heat emitter temperature, where additional significant heat losses occur from the dynamic effects of heating and cooling the building. This effect is especially shown in evaporating the water from the outside walls during the day, to be replaced by cold water condensing during the night.

FIG. 1 illustrates that the insulating device 5 thermally isolates the wall 10 behind the heat emitter 21 from the heat emitter 21 itself, by means of an air filled sealed unit 13, the insulating device 5 positioned between the plurality of transverse right angle sections 16, the front protective cover 15 and the flat inner radiant barrier of impermeable aluminum sheet 12 with a laminated polymer backing sheet 11 forming a sealed unit. The area directly behind the heat emitter 21 is where the temperature range is greatest and where the introduction of the insulating device 5 produces further substantial savings in eliminating the transient component of heat loss from night-time setback of heat emitter temperature.

FIG. 1 illustrates that the insulating device 5 reduces convective heat transfer due to a series of eddies or vortices 19 in the small hollows of the plurality of transverse right angle sections 16 of white heat deflective polymer forcing the hot gases away from the surface of the thermal insulating device 5, creating a fluid limit layer of stagnant air 24 on the face of the insulating device 5 narrowing the gap 22 between the insulating device 5 and the heat emitter 21. The narrowing of the airspace between the heat emitter 21 and the insulating device due to the vortex effect improves the heat output of the heat emitter 21 by increasing the velocity of air 23 that flows between the stagnant air layer 24 and the heat emitter 21, and the front of the insulating device 15 stays cool to the touch. The substantially vertical airflow, which may be generated by the heat from a heat emitter 21, does not penetrate the sealed unit insulating device 5.

FIG. 6 illustrates that the insulating device 5 improves the velocity of the air stream 29 over both sides of the heat emitter 21 extending the air stream 29 for a predetermined distance which may be two to three meters above the heat emitter 21 and out into the room. The improved air circulation 29 increases the comfort level in the room, and at the same time, the insulating device 5 pushes the hot airstream 29 away from the wall, which eliminates the deterioration of the wall coatings behind and above a heat emitter and eliminates grease, dust, and dirt from being deposited on the wall surface by static electricity.

FIG. 1 illustrates that the installation of the insulating device 5 returns water to the boiler at a higher temperature requiring less energy to bring the water temperature back up to a set temperature thereby saving on fuel bills. The insulating device 5 may include a flat white heat deflective polymer back 11 laminated to an impermeable aluminum sheet 12 covered with adhesive to attach the insulating device 5 to a wall surface 10 behind a heat emitter 21.

FIG. 3 illustrates that the installation of the modular insulating device 5 may require reducing or increasing the size of the insulating device 5 to fit heat emitter dimensions. Horizontal 25 and vertical 26 channels are provided to allow the modular sections 42 to be cut to exact size of any heat emitter 21 dimensions.

FIG. 10 illustrates that with forced air-conditioned ducting, the insulating device 5 reduces convective heat transfer on all sides or on the circumference of the duct by lifting and elevating the airflow away from the retrofit/installed or manufactured new surface of the ducting creating a limit layer of stagnant air between the insulating device 5 and the forced airflow. The insulating device profile may be lengthened and or shaped to accommodate different airflow strengths in duct sections.

The insulating device 5 manages humidity (water vapor) on both the front and back surfaces acting as a gas and moisture barrier. The flat aluminum back is laminated with a white heat deflective polymer 11 to the matte/non reflective side of the aluminum surface 12 of the insulating device 5 and is bonded to an external or party wall 10 with adhesive, glue or Velcro or other material.

The thermal insulation achieved by the insulating device 5 modifies the convective, conductive and radiant heat transfer between wall 10 and heat emitter 21, so as to significantly reduce losses to the wall saving up to 35% on fuel consumption at the boiler depending on the boiler size and heat emitter shape, configuration or type, resulting in an equivalent reduction of CO2 emissions per average home per year.

The front of the modular insulating device 5 may be a white heat deflective polymer or other material having horizontal ridges, such that a cross-section approximates a right triangular section with teeth facing upwards. The tooth pitch may be approximately 30 mm long, and the distance between the front surface and the rear surface varies linearly from about 2-3 mm at the bottom of a tooth to about 7-8 mm at the top.

The insulating device 5 may have no moving parts and no recurring expense. Unlike heating equipment, the insulating device 5 may be permanent and may not require maintenance, upkeep, or adjustment. The present device invention will produce greenhouse gas savings year on year.

Clearly, the extent of fuel saving from the installation of the insulating device 5 may vary from one building to the next given different construction materials, usage patterns, whether the building is insulated or not insulated, stand alone or terraced.

The back surface of the insulating device 5 may be substantially vertical and parallel to the surface of the wall. The modular front protective cover 15 may be formed of white heat deflective polymer profiled material of the insulating device 5 may include a plurality of right angle sections 16 that are formed in a substantially periodic nature and between the horizontal surfaces 14 is an inclined surface 17, which extends outwards to the edge of the horizontal surface 14.

The flat back of the white heat deflective polymer laminated to an aluminum surface of the insulating device 5 has an elastic adhesive cover 11 or strips which may extend to all four sides of the insulating device that may be for attachment to the wall. The attachment member may be permanently bonded to the wall or may be detachably connected to the wall. The bonding member may be a layer of adhesive, Velcro, double-sided tape or any other appropriate bonding device. The adhesive on the polymer laminated to the aluminum back of the insulating device 5 may be covered with a liner to prevent contamination of the adhesive before it is used to bond it to the wall.

Radiant heat fluxes are so much greater than convective so that a flat aluminum radiant surface 12 is employed. The inner radiant aluminum surface 12 is kept clean and completely protected by a profiled front white heat deflective polymer 11 or other cover material, thereby allowing heat rays to be re-emitted or reflected unimpeded by grease, dirt or dust deposits on its front flat aluminum surface 12 back towards the heat source.

The effective thermal isolation of the modular insulating device 5 from the external or party wall 10 is due in part to the air filled space between the inner radiant aluminum sheet 12 and the front white heat deflective polymer 11 or other material front cover. The airflow moving upwards over the right triangular shaped section 16 of the front white heat deflective polymer cover 11 of the insulating device 5 has the effect of establishing eddies or vortices in the horizontal valleys creating a layer of stagnant air that pushes the hot air flow away from the front white heat deflective surface of the insulating device, keeping it substantially cool to the touch even with close proximity of a very hot heat emitting surface of a heat emitter 21.

The eddies or vortices in the horizontal valleys form a fluid limit layer 24 of stagnant air in front of the system insulating device 5 pushing the hot airflow away from the insulating device 5 and in doing so reduces the air gap between the heat emitter 21 and the insulating device 5 greatly strengthening the hot upward airflow thus bringing a more desirable flow pattern on both sides of the heat emitter 21 leading to larger convective savings and meeting and heating the downward flow of cold air above the heat emitter 21 and carrying the hot airflow thermodynamically from behind the heat emitter 21 into the room in a substantially figure of eight pattern returning from the far wall to the corner under the heat emitter 21 giving a powerful upward flow into the gap between heat emitter 21 and the profiled white heat deflective polymer insulating device 5.

With a night-time setback of heat emitter temperature, additional significant heat losses occur from the dynamic effects of heating and cooling the building, especially in evaporating water from outside walls during the day, to be replaced by cold water condensing during the night. One effect of the insulating device 5 is to thermally isolate the wall 10 behind the heat emitter 21 from the heat emitter 21 itself by encapsulated still air, which is a good insulator and consequently is a poor conductor. The wall area 10 directly behind the heat emitter 21 is just where the temperature range is greatest and with the insulating device 5 in place, a substantial saving may be made in the reduction of the transient component of heat loss from night-time setback of heat emitter temperature.

FIG. 4 illustrates differing insulating device module sizes 43 with horizontal cut or bonding lines 26 where dimensions of heat emitters 21 are known and speed of installation is increased by installers ordering insulating device 5 being sized corresponding to the height of heat emitters 21 where only vertical cut and bond channels are required to increase or reduce width.

FIG. 5 illustrates a heat emitter 12 manufactured with an insulating device 5 as an integral part of a heat emitter design where the insulating device 5 is fixed to the wall replacing the wall brackets and the heat emitter 12 is hung or fixed to the insulating device employing bolts, screws or other methods forming a new heat emitter unit 12.

FIG. 6 illustrates improved air circulation with an insulating device 5 fixed to a wall 10 behind a heat emitter 21 with a substantially vertical airflow, which is generated by the heat from the heat emitter 21. Substantially, the air does not penetrate the insulating device 5 and is swept thermodynamically out into the room in a figure of eight pattern meeting and heating the cold air coming down the wall and returning with a strong flow back under the heat emitter 21.

FIG. 7 illustrates air circulation without an insulating device fixed to a wall 10 behind a heat emitter 21 where the airflow generated by the heat emitter 21 is substantially horizontal and convective air flows substantially unimpeded to the wall 10, reducing convective airflow into the room;

FIG. 11 illustrates the insulating device 5 as a new or retrofit manufactured forced air ducting as built-in insulation of the present invention.

While the insulating device 5 of the present invention is susceptible to various modifications such as a front profiled aluminum sheet 12 laminated or painted with an adhesive flat paper or other material back and alternative forms, specific embodiments thereof have been shown by way of example in the figures and are herein described in detail. It should be understood, however, that the description herein of specific embodiments is not intended to limit the invention to the particular forms disclosed.

With air condition ducting, the insulating device 5 reduces convective heat transfer on all sides or circumference of a duct lifting and elevating the airflow away from the surface of the device creating a limit layer of stagnant air between the device and the forced airflow. The fans forcing airflow will be assisted by this action thereby saving energy.

Factors in the design of a duct thermal insulation device include the flow rate (which is a function of the fan speed and exhaust vent size) and noise level. If forced air in the ducting, has to traverse unheated space such as an attic, the ducting insulated internally by a limit layer of stagnant air prevents condensation on the ducting.

Although embodiments have been described with reference to a number of illustrative embodiments thereof, it should be understood that numerous other modifications and embodiments can be devised by those skilled in the art that will fall within the spirit and scope of the principles of this disclosure. Various variations and modifications are possible in the component parts and/or arrangements of the subject combination arrangement within the scope of this disclosure, the figures and the appended claims. In addition to variations and modifications in the component parts and/or arrangements, alternative uses will also be apparent to those skilled in the art.

1. A multi-purpose insulating device that reduces fuel consumption by up to 40% thereby increasing the value of fuel storage by the percentage of fuel savings and restricts the transmission of oxygen, water and microorganisms into the air in the space to be heated and in the process reduces carbon emissions equal to the fuel savings, comprising:
a thick non-toxic flat aluminum sheet laminated to a flat white heat deflective polymer on the matte side of the flat aluminum sheet, wherein the thick aluminum sheet is impermeable to oxygen, water and microorganisms; and
wherein the thickness of the aluminum sheet eliminates the probability of pinholes and foil fractures in the aluminum foil from occurring during fabrication, handling and installation of the device, and wherein
a reflective side of the aluminum sheet is permanently bonded to a white profiled heat deflective modular square or rectangular shaped polymer or other material front protective cover which includes a plurality of transverse right angle shapes and is divided into air filled modules; wherein
the multi-purpose insulating device is placed between a wall and a heat emitter with the matte side of the flat aluminum sheet laminated with a flat sheet of white heat deflective polymer including a layer of adhesive and protective liner covering the flat polymer surface to be bonded to a wall when the liner is removed or left freestanding with the liner intact; wherein
the flat polymer sheet is laminated to the aluminum sheet to prevent the aluminum sheet from sagging between the air filled modules and the front polymer protective cover and preventing heat loss by conduction; wherein
the multi-purpose insulating device creates benefits by reducing heat exchange from a heat emitter to a wall from the deleterious effects of convection, conduction and radiation on a building envelope directly behind and above a heat emitter that is freestanding or fixed to a wall; wherein
the multi-purpose insulating device eliminates heat exchange from the heat emitter to the wall removing the potential release of fine particulate matter from the wall area behind the heat emitter into the air in the space to be heated.

2. The multi-purpose insulating device as in claim 1, wherein the insulating device is a semi-rigid and flexible device with a plurality of transverse right angle shapes on the front surface that are divided into square and rectangular shaped modules and bonded to the reflective side of a thick flat aluminum sheet which has a supporting polymer sheet bonded to the matte side of the aluminum sheet creating enclosed air filled spaces that reduce the heat losses from conduction without which a heat emitter would otherwise need to maintain a designed heat loss from conduction through the wall fabric of the building directly behind a heat emitter before it is able to heat the air in a room.

3. The multi-purpose insulating device as in claim 1, wherein the airflow over the plurality of transverse right angle shapes of white heat deflective polymer of square and rectangular shaped modules on the front cover of the insulating device induce eddies or vortices to form in the hollow of each shape keeping the white front surface cool to the touch and clean from grease, dust and dirt deposits, wherein the eddies or vortices force the convective airflow away from the insulating device front cover surface back towards the heat source and out into the space to be heated thereby reducing the airflow space which has the effect of increasing the airflow velocity in the space between the insulating device and heat emitter which has a positive effect on the airflow over both sides of the emission surfaces of a heat emitter improving both the heat output of the heat emitter and the velocity of the airflow into the space to be heated causing a faster warm up time to occur in the space to be heated using less heating fuel and therefore using less fuel storage space in the process.

4. The multi-purpose insulating device as in claim 1, wherein the front white profiled heat deflective polymer modular square and rectangular shaped cover protects the flat radiant aluminum sheet surface from grease, dust and dirt being deposited on its reflective surface thereby retaining its emissivity and allowing it to continuously, without obstruction reflect or re-emit 98% of the medium and far infrared radiation back towards the heat source and out into the space to be heated.

5. The multi-purpose insulating device as in claim 1, wherein placed between a heat emitter and a wall, the heat emitter is either freestanding or fixed to the wall and where the temperature range is greatest, and where the insulating device produces fuel savings by reducing the preheating time of a building by eliminating the effect of transient heat loss from night-time setback of heat emitter temperature where heat losses occur from the dynamic effects of heating and cooling a building, especially in evaporating water from outside walls during the day, to be replaced by cold water condensing during the night.

6. The multi-purpose insulating device as in claim 1 wherein the insulating device saves fuel in the space to be heated by returning water to the boiler at a higher temperature therefore the thermostat setting must be lowered to achieve the same level of comfort without the insulating device installed behind a heat emitter a poorly insulated wall can drop as much as 10 degrees in an hour.

7. The multi-purpose insulating device as in claim 1, wherein the insulating device reduces heat loss from a heat emitter to the wall fabric of a building, wherein this heat loss increases the temperature differential gradient between the inside and outside of the wall fabric, wherein higher the temperature gradient differential the higher the heat loss will be through the wall behind and above the heat emitter, wherein insulating device stops this thermal transfer of heat through the wall saving energy consumption at the boiler or furnace.

8. The multi-purpose device as in claim 1, wherein the square or rectangular shaped air filled modules have a channel around the perimeter of each separate air filled module to protect the structural integrity of the air filled insulation space when separating the modules with a knife or cutter to increase or decrease the device size to accommodate
the many heat emitter sizes.

9. The multi-purpose insulating device as in claim 1, wherein the insulating device insulates a heat emitter of any dimension from heat loss wherein the insulating device member is an integral part of a new heat emitter inventive design or new ducting insulation or as a retrofit to insulate existing forced air ducting.

10. The multi-purpose insulating device as in claim 1, wherein the insulating device insulates a heat emitter of any dimension from heat loss, wherein the insulation device prevents a breakdown of cavity wall insulation materials and the deterioration and discoloration of the wall behind and above a heat emitter by pushing the convective airflow away from the wall and preventing a breakdown of wall coatings of paper, paint, or plaster and other materials behind a heat emitter by reducing thermal exchange in the wall area behind and above a heat emitter.

11. The multi-purpose insulating device as in claim 1, wherein the insulating device reduces the heat loss effects from thermal exchange of convection, conduction and radiation, wherein the thermodynamics convection refers specifically to heat transfer by movement of warm particles, conduction involves direct contact of atoms and radiation involves the movement of electromagnetic waves wherein the insulating device thermodynamically improves air quality and air circulation by improving the heat output of the heat emitter in the space to be heated wherein the insulating device is retrofitted to existing heat emitters or included as an integral part of new heat emitter manufacture significantly reducing heat transfer by insulating the wall directly behind and above a heat emitter from the heat emitter itself.

12. The multi-purpose insulating device as in claim 1, wherein the insulating device achieves regardless of the fuel source be it solar, geothermal, natural gas, electric, solid fuel, wind or another fuel source a fuel saving by reducing the effect of a designed heat loss in the wall fabric of a building, wherein the effect of eliminating the heat loss through the wall behind the heat emitter increases the comfort level of the space to be heated by improving the quality and circulation of air by causing a stronger fluid flow of hot air into the space to be heated, wherein the installation of a device member to a wall behind a heat emitter ensures that the water in the heating system now returns to the boiler at a higher temperature allowing for a lower thermostat setting to achieve the same level of comfort using less energy and thereby reducing the financial cost of space heating.

13. The multi-purpose insulating device as in claim 1, wherein the insulating device eliminates the need for a heat emitter to maintain a designed heat loss in the wall fabric of a building caused by moisture migration in the molecular makeup of brick, cement, wood, insulation fibers and other organic materials, wherein molecules contain moisture and when heat is introduced to a molecule moisture expansion occurs leading to moisture migration carrying the heat through the building fabric of a wall and out of the building.

14. The multi purpose insulating device as in claim 1, wherein the insulating device is freestanding or fixed to the wall reduces fuel waste at the boiler, principally due to the elimination of the “primary loss” of heat through the wall fabric directly behind and above the wall or window, and wherein a heat emitter is either freestanding or fixed to a wall, wherein installing an insulating device increases the thermal resistance of the wall and reduces the radiant heat transfer to the wall while increasing the airflow over both sides of the heat emission surface of the heat emitter improving its heat output into the space to be heated.

15. The multi-purpose insulating device as in claim 1, wherein the insulating device improves the air circulation in a clockwise eddy to carry warm air to the far wall, returning to the corner under the heat emitter, and wherein the improved airflow will give the air a powerful upward flow into the gap between the heat emitter and the stagnant air limit layer formed in front of the insulating device, wherein the improved upward hot air flow speed on both sides of the heat emitter meet and heat the cold airflow coming down the wall thermodynamically sweeping the now heated air above the heat emitter out into the room in a clockwise eddy positively modifying the flow pattern of heated air in the space to be heated.

16. The multi-purpose insulating device as in claim 1, wherein the insulating device is made up of components of white heat deflective polymer and aluminum that do not endanger the health of workers, consumers or the environment and all components of the modular insulating device.
